(19) United States
(12) Patent Application Publication
(10) Pub. No.: US 2007/0143001 A1
(43) Pub. Date: Jun. 21, 2007

(54) Method and system for collecting traffic information in real time using wireless communication

(75) Inventors: Pu Sik Park, Yongin (KR); Dae Kyo Shin, Seoul (KR); Ki Tag Lim, Yongin (KR); Jae Min Kwak, Osan (KR); Jong Chan Choi, Pyungtaek (KR)

Correspondence Address: SUGHRUE MION, PLLC, 2100 PENNSYLVANIA AVENUE, N.W., SUITE 800, WASHINGTON, DC, 20037, US

(73) Assignee: KOREA ELECTRONICS TECHNOLOGY INSTITUTE

(21) Appl. No.: 11/315,373

(22) Filed: Dec. 23, 2005

(30) Foreign Application Priority Data
Dec. 20, 2005 (KR) 10-2005-0126052

(51) Int. Cl. G08G 1/00

(52) U.S. Cl. 701/117

(57) ABSTRACT

The present invention is related to a method and a system for collecting traffic information in real time using wireless communication wherein a traffic information of a shadow region outside a communicable range is transmitted to a RSE (Road Side Equipment) using a communication between OBEs (On-board Equipments). In accordance with the present invention, the traffic information related to a shadow region is relayed to the RSE using a two-way communication between the OBEs and/or the OBE and sensors to be collected by the RSEs and a central server.

### RELATED APPLICATIONS

The present disclosure relates to subject matter contained in priority Korean Application No. 10-2005-0126052 filed on 20 Dec. 2005, which is herein expressly incorporated by reference in its entirety.

### BACKGROUND OF THE INVENTION

1. Field of the Invention

The present invention relates to a method and a system for collecting traffic information in real time using wireless communication, and in particular to a method and a system for collecting traffic information in real time using wireless communication wherein a traffic information of a shadow region outside a communicable range is transmitted to a RSE (Road Side Equipment) using a communication between OBEs (On-board Equipments).

2. Description of the Related Art

FIGS. 1a and 1b are block diagrams illustrating a conventional system and method for collecting/offering a traffic information using DSRC (Dedicated Short Range Communication) method.

FIGS. 1a and 1b illustrate Korean Patent Application No. 2000-11000 by Korea Telecom filed on Mar. 6, 2000 and published on Sep. 15, 2001 (Patent Publication No. 2001-86969) titled “TRAFFIC INFORMATION COLLECTION/OFFER SYSTEM AND METHOD USING DSRC”.

Referring to FIG. 1a, the conventional system comprises for collecting/providing the traffic information using DSRC comprises a vehicle terminal 11, an OBE 12, a RSE 13, a regional traffic information server 14 and a central traffic information server 15. The vehicle terminal 11 serves a function of an interface with a user. That is, the vehicle terminal 11 transmits a service requested by the user to the OBE 12 and receives an information from the OBE 12 to be displayed on a display. The OBE 12 converts an information transmitted from the vehicle terminal 11 to a format suitable for the DSRC method and transmits the same to the RSE 13 or receives an information transmitted from the RSE 13. The RSE 13 receives an ID of a vehicle passing through a communicable region covered by the RSE 13 from the OBE 12 to be transmitted to the regional traffic information server 14 through a high-speed line, and also receives an information transmitted from the regional traffic information server 14 and transmits the same to the OBE 12 of the vehicle passing through the communicable region. The regional traffic information server 14 receives the ID of the vehicle transmitted from the RSE 13 to record a time at which the vehicle passes by the RSE 13, and obtains a time period elapsed for the vehicle to pass from one RSE to other RSE to calculate a sectional speed of the vehicle by dividing a distance between the two RSEs by the time period. The sectional speeds are collected and processed to be transmitted to the central traffic information server 15 and the sectional speed is transmitted to the RSE 13 in the corresponding section. The central traffic information server 15 collects informations from the regional traffic information server 14 and other traffic information systems for a central management. In addition, the central traffic information server 15 provides an interface for providing a traffic information using the Internet, a fax and an ARS.

In accordance with the conventional system and method for collecting/offering a traffic information using DSRC (Dedicated Short Range Communication) method, a disadvantage of using a dual system including a first system wherein a loop detector installed on a road surface, a CCTV (Closed Circuit Television), an image detector and an ultrasonic sensor are used to collect a sectional traveling speed of a vehicle on the road, and a second system wherein information collected by the first system is provide to a moving car through a wireless communication network such as a cellular phone, a PCS (Personal Communication system) and a wireless data communication network which, in turn, requires a high installation and a high maintenance cost and also requires a separate communication system in order to provide the collected traffic information, is solved. However, when the vehicle stops in a shadow region where a communication between the OBE and the RSE cannot be established, an information on a status of the stopped vehicle cannot be obtained. In order to remove the shadow region, a distance between the RSEs should be reduced. This increase the installation and the maintenance cost.

FIG. 2 is a block diagram illustrating a conventional geographic information service apparatus and method using a DSRC network.

FIG. 2 illustrate U.S. Pat. No. 6,756,915 by LG Electronics filed on Oct. 25, 2001 and registered on Jun. 29, 2004 titled “GEOGRAPHIC INFORMATION SERVICE APPARATUS AND METHOD USING A DSRC NETWORK”.

Referring to FIG. 2, the geographic information service apparatus includes a geographic information supply server 500 supplying geographic information related to certain regions, an Electronic Toll Collection (ETC) terminal 100 installed in a vehicle 100A and transmitting registration information and geographic information service requests from the vehicle, a plurality of DSRC base stations 200 through 203 each installed in a certain region and performing two-way communication with the ETC terminal 100 by the DSRC method, and a DSRC server 400 in communication with the DSRC base stations 200 through 203, via a dedicated DSRC network 300.

In accordance with the conventional geographic information service apparatus, while the geographic information may be provided to a moving vehicle, an information on a status of the vehicle cannot be obtained when the vehicle stops in the shadow region. In order to remove the shadow region, a distance between the RSEs should be reduced. This increase the installation and the maintenance cost similar to the conventional art shown in FIGS. 1a and 1b.

### SUMMARY OF THE INVENTION

It is an object of the present invention to provide a method and a system for collecting traffic information in real time using a wireless communication wherein the traffic information of a shadow region is relayed to a RSE using a two-way communication between OBEs and/or the OBE and sensors.

In order to achieve the object of the present invention, there is provided a method for collecting traffic information in real time using a wireless communication, the method comprising: transmitting a vehicle status information of a first vehicle from a first OBE installed in the first vehicle to a second OBE installed in a second vehicle passing by the first vehicle, wherein the first vehicle is positioned in a shadow region outside a communicable range between the first OBE and a RSE; and transmitting the vehicle status information from the second OBE to a first RSE when the second vehicle is within the communicable range with the first RSE.

In order to achieve the object of the present invention, there is also provided a system for collecting a traffic information in real time using a wireless communication, the system comprising: a first RSE and a second RSE spaced apart from each other along a side of a road; a first OBE installed in a first vehicle positioned in a shadow region outside a communicable range, the first OBE communicating with the first RSE and the second RSE; and a second OBE installed in a second vehicle, the second OBE communicating with the first OBE, the first RSE and the second RSE; wherein the second OBE of the second vehicle passing the first vehicle receives a vehicle status information of the first vehicle from the first OBE to be transmitted to one of the first RSE and the second RSE when the first vehicle reaches the communicable range between the second OBE and one of the first RSE and the second RSE.

### BRIEF DESCRIPTION OF THE DRAWINGS

FIGS. 1a and 1b are block diagrams illustrating a conventional system and method for collecting/providing a traffic information using a DSRC (Dedicated Short Range Communication) method.

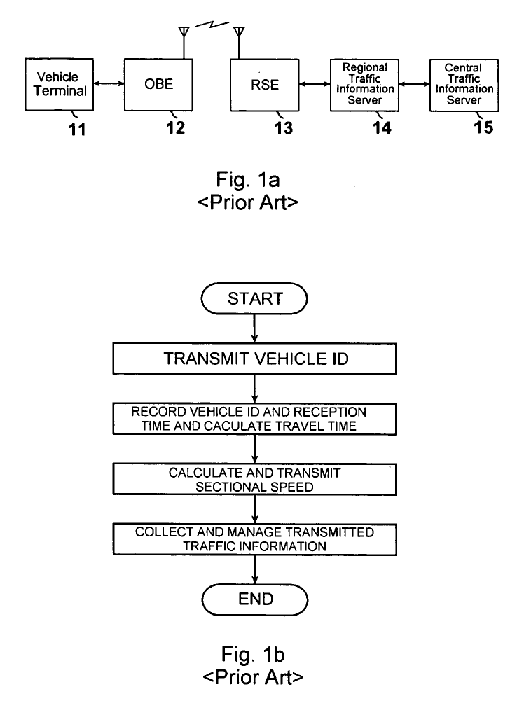

FIG. 2 is a block diagram illustrating a conventional geographic information service apparatus and method using a DSRC network.

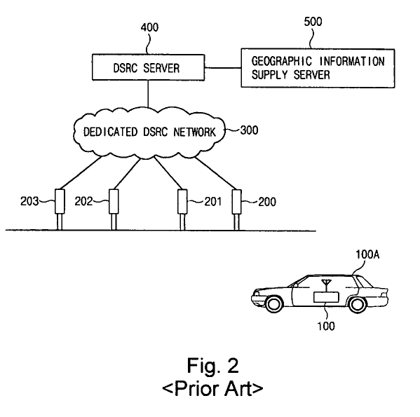

FIGS. 3a and 3b are schematic diagrams illustrating a method and system for collecting traffic information in real time using wireless communication in accordance with a first preferred embodiment of the present invention.

FIGS. 4a and 4b are schematic diagrams illustrating a method and system for collecting traffic information in real time using wireless communication in accordance with a second preferred embodiment of the present invention.

### DETAILED DESCRIPTION OF THE INVENTION

Method and system for collecting traffic information in real time using wireless communication in accordance with the present invention will now be described in detail with reference to the accompanied drawings.

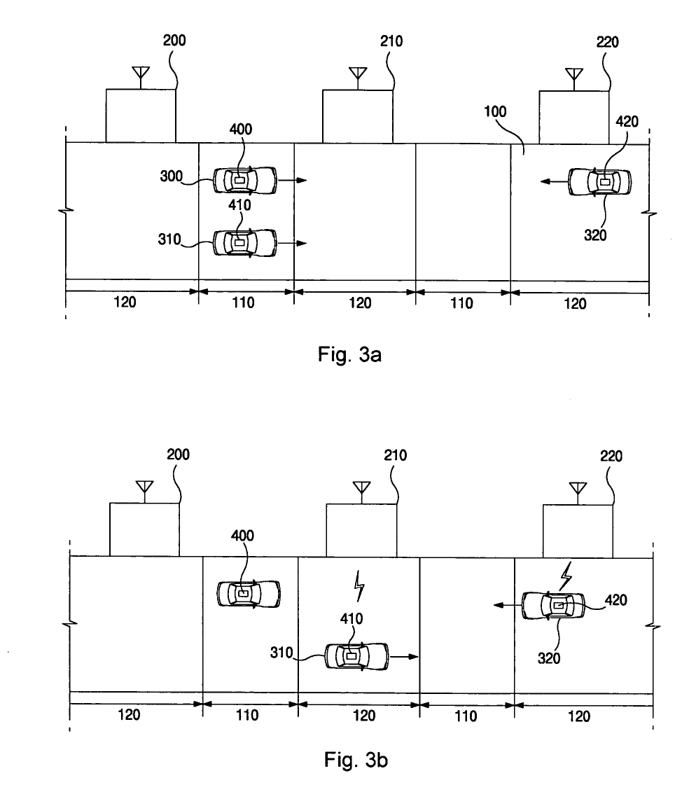

FIGS. 3a and 3b are schematic diagrams illustrating a method and system for collecting traffic information in real time using wireless communication in accordance with a first preferred embodiment of the present invention.

Referring to FIGS. 3a and 3b, the system for collecting a traffic information in real time using a wireless communication comprises a plurality of RSEs including a first RSE 200, a second RSE 210 and a third RSE 220 spaced apart from each other along a side of a road 100, a first OBE 400 installed in a first vehicle 300 for communicating bi-directionally with the RSEs, and a second OBE 410 installed in a second vehicle 310 for communicating with the first OBE 400 and the RSES. The RSEs establishes a wireless communication with OBEs and also communicates with other RSEs to share a road and traffic information. Since the RSEs are installed to be spaced apart from each other, a portion of the road 100 wherein the OBE cannot communicate with one of the RSE, namely a shadow region 110 exists. This is due to the fact that a communicable region 120 that is covered by the RSEs is small since the DSRC (Dedicated Short Range Communication) method is employed. Therefore, the shadow region 110 where a communication between the OBE and the RSE cannot be established exists.

The method for collecting traffic information in real time using wireless communication in accordance with the present invention is carried out as the following in the system for collecting traffic information in real time using wireless communication comprising RSEs and OBEs.

As shown in FIG. 3a, when the first car stops in the shadow region due to a breakdown such as mechanical/electrical failure or a traffic accident, the first OBE 400 installed in the first vehicle 300 cannot establish a communication with the first RSE 200 and the second RSE 210. In this case, unless a driver of the first vehicle 300 carries means for communication such as a cellular phone, a state of his or her car, namely a vehicle status information, cannot be reported to the police or to someone that may provide a help to the driver. Even when the driver provide vehicle status information to the police, it is impossible for vehicles traveling not far from the first vehicle 300 to know the status of the first vehicle 300. Therefore, the first vehicle 300 may be a potential danger to other vehicles. In this case, the first OBE 400 transmits the vehicle status information of the first vehicle 300 to the second OBE 410 installed in the second vehicle 310. The vehicle status information may comprise a mechanical/electrical failure, a traffic accident state and a position of the first vehicle 300.

When the second vehicle 310 reaches the communicable region 120, i.e. is within a communicable range with the second RSE 210 as shown in FIG. 3b, the second OBE 410 transmits the vehicle status information to the second RSE 210. The second RSE 210 broadcasts the vehicle status information other RSEs such as a third RSE 220, and the third RSE 220 may transmit a traffic situation information including the vehicle status information to a third vehicle 320 passing by the third RSE 220 so that a driver of the third vehicle 320 recognizes the potential danger.

Preferably, a method for transmitting the vehicle status information from the first OBE 400 to the second OBE 410 is an ALOHA, a slotted ALOHA, a CSMA-CA, a TDMA or a Reservation method. In addition, a method for transmitting the vehicle status information from the second OBE 410 to the second RSE 210 may be the DSRC method.

While FIGS. 3a and 3b illustrate a case where moving directions (direction of arrows) of the first vehicle 300 and the second vehicle 310 are identical, it is obvious to the skilled in the art that the moving directions (direction of arrows) of the first vehicle 300 and the second vehicle 310 may be opposite. In this case, the second vehicle 310 transmits vehicle status information to the first RSE 200.

As described above, since a two-way communication between the OBEs is possible, the traffic information may be transmitted to every car on the road 100 even when a point of the accident or breakdown of the vehicle is in the shadow region 110.

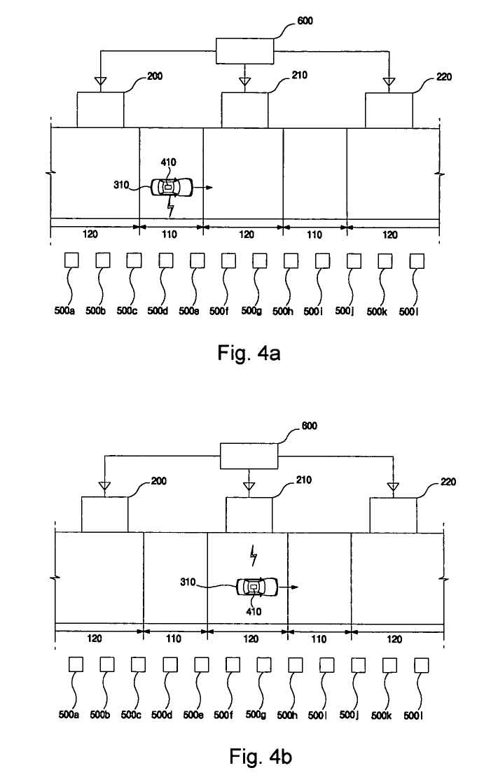

FIGS. 4a and 4b are schematic diagrams illustrating a method and system for collecting traffic information in real time using wireless communication in accordance with a second preferred embodiment of the present invention, wherein like numerals denote like components.

In accordance with the second preferred embodiment, sensors 500a through 5001 installed along the road 100 are further included compared to the first preferred embodiment. Therefore, a description will be focused on a difference between the first and the second preferred embodiments.

The sensors 500a through 5001 collects an information on a traffic situation such as a temperature, a humidity and a fire information to be transmitted to the first RSE 200 through the third RSE 220. However, the sensor installed in the shadow region 110, the sensor 500d for example cannot establish a communication with neither the first RSE 200 nor the second RSE 210. Therefore, the information on the traffic situation cannot be reported. In accordance with the present invention, the sensor 500d transmits the collected the information on the traffic situation to the second OBE 410 of the second RSE 210 passing the shadow region 110. The second OBE 410 of the second vehicle 310 then transmits (relays) the information on the traffic situation to the second RSE 210 when the second vehicle 310 reaches the communicable region 120. The second RSE 210 then transmits the information on the traffic situation to other RSEs or to a central server 600 so that a comprehensive traffic management is possible.

As described above, in accordance with the method and the system for collecting traffic information in real time using wireless communication in accordance with the present invention, since a communication between the OBEs or the OBE and the sensors is possible, an traffic accident situation or a road situation in the shadow region may be easily relayed to the RSES. In addition, a distance between the RSEs may be increased because the situation in the shadow region may be reported to the RSE or the central server, thereby reducing an installation and a maintenance costs.

While the present invention has been particularly shown and described with reference to the preferred embodiment thereof, it will be understood by those skilled in the art that various changes in form and details may be effected therein without departing from the spirit and scope of the invention as defined by the appended claims.

What is claimed:

1. A method for collecting traffic information in real time using a wireless communication, the method comprising:
transmitting a vehicle status information of a first vehicle from a first OBE installed in the first vehicle to a second OBE installed in a second vehicle passing by the first vehicle, wherein the first vehicle is positioned in a shadow region outside a communicable range between the first OBE and a RSE; and
transmitting the vehicle status information from the second OBE to a first RSE when the second vehicle is within the communicable range with the first RSE.

2. The method in accordance with claim 1, further comprising transmitting the vehicle status information from the first RSE to a second RSE.

3. The method in accordance with claim 2, further comprising transmitting the vehicle status information from the first OBE and the second OBE to a third OBE.

4. The method in accordance with claim 1, wherein a method for transmitting the vehicle status information from the first OBE to the second OBE is selected from a group an ALOHA, a slotted ALOHA, a CSMA-CA, a TDMA and a Reservation methods, and wherein a method for transmitting the vehicle status information from the second OBE to the first RSE comprises DSRC.

5. The method in accordance with claim 1, further comprising:
transmitting a traffic situation information of the shadow region collected by a sensor disposed in the shadow region from the sensor to the second OBE of the second vehicle passing the shadow region; and
transmitting the traffic situation information from the second OBE to the second RSE when the second vehicle is within the communicable range with a second RSE.

6. The method in accordance with claim 5, wherein the first RSE and the second RSE are disposed along a side of a road, the first RSE and the second RSE spaced apart from each other, and wherein the shadow region is disposed between the first RSE and the second RSE.

7. The method in accordance with claim 1, wherein the vehicle status information of the first vehicle comprises a mechanical/electrical failure, a traffic accident state and a position of the first vehicle.

8. The method in accordance with claim 5, wherein the traffic situation information comprises an information on a temperature, a humidity and a fire.

9. The method in accordance with claim 1, wherein a moving direction of the second vehicle is identical to that of the first vehicle before a stop thereof.

10. A system for collecting a traffic information in real time using a wireless communication, the system comprising:
a first RSE and a second RSE spaced apart from each other along a side of a road;
a first OBE installed in a first vehicle positioned in a shadow region outside a communicable range, the first OBE communicating with the first RSE and the second RSE; and
a second OBE installed in a second vehicle, the second OBE communicating with the first OBE, the first RSE and the second RSE;
wherein the second OBE of the second vehicle passing the first vehicle receives a vehicle status information of the first vehicle from the first OBE to be transmitted to one of the first RSE and the second RSE when the first vehicle reaches the communicable range between the second OBE and one of the first RSE and the second RSE.

11. The method in accordance with claim 10, wherein a method for transmitting the vehicle status information from the first OBE to the second OBE is selected from a group ALOHA, slotted ALOHA and CSMA-CA methods.

12. The method in accordance with claim 10, wherein the shadow region is disposed between the first RSE and the second RSE.

13. The method in accordance with claim 10, further comprising a sensor for collecting a traffic situation information.

14. The method in accordance with claim 13, wherein the sensor collects the traffic situation information to be transmitted to the second OBE of the second vehicle passing by the shadow region to be transmitted to the second RSE when the second vehicle reaches the communicable range.

15. The method in accordance with claim 10, wherein a method for transmitting the vehicle status information from the second OBE to the first RSE comprises DSRC.
